(19) United States
(12) Patent Application Publication
(10) Pub. No.: US 2024/0070705 A1
(43) Pub. Date: Feb. 29, 2024

(54) INFORMATION PROCESSING SYSTEM, NOTIFICATION PROVIDING METHOD, AND PORTABLE TERMINAL

(71) Applicant: NEC Corporation, Minato-ku, Tokyo (JP)

(72) Inventors: Hideo Urai, Tokyo (JP); Tasuku Yoshihiro, Tokyo (JP); Sakie Morita, Tokyo (JP); Yuto Nakaya, Tokyo (JP); Kei Shibukawa, Tokyo (JP)

(73) Assignee: NEC Corporation, Minato-ku, Tokyo (JP)

(21) Appl. No.: 18/270,115

(22) PCT Filed: Feb. 8, 2021
(86) PCT No.: PCT/JP2021/004615

§ 371 Date: Jun. 28, 2023

(51) Int. Cl. G06Q 30/0207

(52) U.S. Cl. CPC G06Q 30/0222

(57) ABSTRACT

A information processing system according to an aspect of the present disclosure includes: at least one memory configured to store instructions; and at least one processor configured to execute the instructions to: identify, when a discount condition is satisfied in a case where two or more unregistered products and one or more registered products that were registered by an operation by a customer using a portable terminal are purchased in a set, a combination of the unregistered products including the two or more unregistered products; and notify the portable terminal of the identified combination of the unregistered products.

### TECHNICAL FIELD

The present disclosure relates to an information processing system and the like.

### BACKGROUND ART

A product sales system in which a customer causes a mobile terminal such as a smartphone owned by the customer to read a barcode of a product and registers the product in a store is known. Such a system is referred to as a self-scan shopping system. For example, PTL 1 discloses a self-scan shopping system that displays a selling price on a mobile terminal of a customer when the selling price is changed according to a predetermined condition such as set selling. PTL 1 discloses, for example, a set discount for a combination of specific products and a total amount discount that occurs when the total amount of purchased products is equal to or more than a predetermined amount of money.

### CITATION LIST

### Patent Literature

PTL 1: WO 2020/174881 A1

### SUMMARY OF INVENTION

### Technical Problem

By providing a set discount or a discount with respect to the total amount as in PTL 1, it is possible to increase the sales amount of the product and the unit price of the customer. In general, in the retail industry, it is desirable to further increase a sales amount of the products and a customer unit price.

An object of the present disclosure is to provide an information processing system or the like that increases the number of products purchased by a customer.

### Solution to Problem

An information processing system according to the present disclosure includes an identification means configured to identify, when a discount condition is satisfied in a case where two or more unregistered products and one or more registered products that were registered by an operation by a customer using a portable terminal are purchased in a set, a combination of the unregistered products including the two or more unregistered products, and a notification means configured to notify the portable terminal of the identified combination of the unregistered products.

A notification providing method according to the present disclosure includes identifying, when a discount condition is satisfied in a case where two or more unregistered products and one or more registered products that were registered by an operation by a customer using a portable terminal are purchased in a set, a combination of the unregistered products including the two or more unregistered products, and notifying the portable terminal of the identified combination of the unregistered products.

A program according to the present disclosure causes a computer to function as an identification means configured to identify, when a discount condition is satisfied in a case where two or more unregistered products and one or more registered products that were registered by an operation by a customer using a portable terminal are purchased in a set, a combination of the unregistered products including the two or more unregistered products, and a notification means configured to notify the portable terminal of the identified combination of the unregistered products.

A portable terminal according to the present disclosure includes an acquisition means configured to acquire identification information about a product by an operation by a customer, and a display means configured to display, when a discount condition is satisfied in a case where a registered product the identification information of which is acquired and that is registered and two or more unregistered products are purchased in a set, a combination of unregistered products including the two or more unregistered products.

A program according to the present disclosure causes a computer to function as an acquisition means configured to acquire identification information about a product by an operation by a customer, and a display means configured to display, when a discount condition is satisfied in a case where a registered product the identification information of which is acquired and that is registered and two or more unregistered products are purchased in a set, a combination of unregistered products including the two or more unregistered products.

### Advantageous Effects of Invention

According to the present disclosure, it is possible to increase the number of products purchased by the customer.

### BRIEF DESCRIPTION OF DRAWINGS

FIG. 1 is a diagram illustrating a configuration of a POS server 11 according to the first example embodiment.

FIG. 2 is a block diagram illustrating a configuration example of a portable terminal 12.

FIG. 3 is a flowchart illustrating an example of a registration process and a notification process of a missing product.

FIG. 4 is a diagram illustrating an example of a product registration screen for reading a product code.

FIG. 5 is a diagram illustrating an example of discount information.

FIG. 6 is a diagram illustrating an example of a screen of a purchase product list displayed on the portable terminal 12.

FIG. 7 is a diagram illustrating an example of information about a missing product displayed on the portable terminal 12.

FIG. 8 is a flowchart illustrating an example of a payment process.

FIG. 9 is a diagram illustrating another example of discount information.

FIG. 10 is a diagram illustrating another example of a screen of a purchase product list.

FIG. 11 is a diagram illustrating another example of information about a missing product displayed on the portable terminal 12.

FIG. 12 is a diagram illustrating a configuration of an information processing system 10 according to the second example embodiment.

FIG. 13 is a flowchart illustrating an operation example of the information processing system 10 according to the second example embodiment.

FIG. 14 is an explanatory diagram illustrating a hardware configuration example of a computer 31.

FIG. 15 is an explanatory diagram illustrating a hardware configuration example of a portable terminal 21.

### EXAMPLE EMBODIMENT

Hereinafter, example embodiments of an information processing system, a method, a program, and a recording medium that non-transiently records the program according to the present disclosure will be described in detail with reference to the drawings. The present example embodiment does not limit the disclosed technology.

### First Example Embodiment

[Configuration]

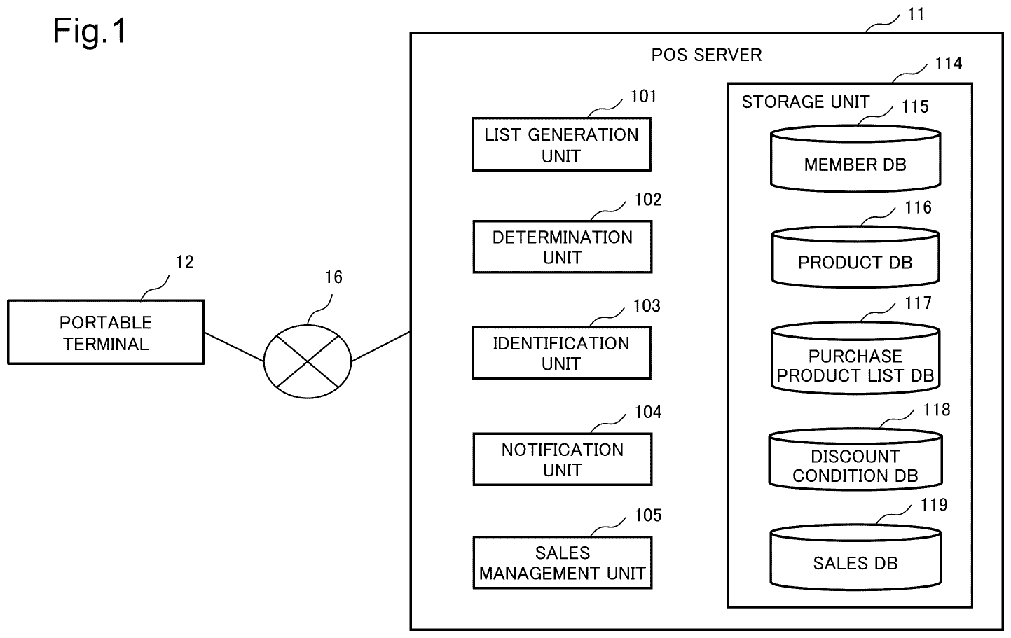

FIG. 1 is a diagram illustrating a configuration of a point of sales (POS) server 11 according to the first example embodiment. The POS server 11 may be connected to a portable terminal 12 via a communication network 16, for example.

<Overview>

The customer performs self-scan shopping using the portable terminal 12. Specifically, the customer acquires a product from a shelf or the like in the store, and registers the product using the portable terminal 12.

In the present disclosure, when a set of predetermined products defined by a store is purchased, a discount is applied. The POS server 11 notifies the portable terminal 12 of information about a discount applied when products are purchased in a set, thereby making notification to the customer.

The discount applied when purchasing products in a set is also referred to as a set discount. In the present disclosure, when one or more products in a set including three or more products are registered, the POS server 11 makes notification of a combination of unregistered products including the remaining two or more unregistered products.

<Details>

The POS server 11 is a server that manages various sales information such as a price, an inventory status, and information about sales of a store regarding products to be sold in the store. The POS server 11 may collectively manage the sales information about a plurality of stores. Alternatively, the POS server 11 may exist for each store. Then, the POS server 11 may manage the sales information of one store.

An example in which the POS server 11 is achieved by one device will be described. However, an achieved example of the POS server 11 is not particularly limited. The POS servers 11 may be achieved by different devices for each function or database (DB).

The POS server 11 includes a list generation unit 101, a determination unit 102, an identification unit 103, a notification unit 104, a sales management unit 105, and a storage unit 114. The storage unit 114 includes a member DB 115, a product DB 116, a purchase product list DB 117, a discount condition DB 118, and a sales DB 119.

The list generation unit 101 generates a purchase product list for each customer. Specifically, the list generation unit 101 generates a purchase product list in which information for identifying a customer, product information about a product to be purchased by the customer, and a purchase quantity are associated with each other, and stores the purchase product list in the purchase product list DB 117. A product included in the purchase product list and to be purchased by the customer is also referred to as a registered product.

The purchase product list is uniquely identified by the information for identifying the customer. The information for identifying the customer is, for example, a customer ID for uniquely identifying the customer. For example, when a customer starts registering a product using the portable terminal 12, the list generation unit 101 assigns a customer ID to the customer. When a period from the start of the registration to the end of the payment is defined as one transaction, the customer ID may be assigned to each transaction.

The product information included in the purchase product list includes information that can uniquely identify a product, such as a product ID. The product information about the purchase product list includes a price of a tax-excluded product or a price of a tax-included product.

The list generation unit 101 updates the purchase product list based on the update request from the portable terminal 12. Specifically, the list generation unit 101 adds or deletes the product included in the purchase product list based on the product information included in the update request. That is, the product to be purchased by the customer is registered using the portable terminal 12 by the operation by the customer.

The list generation unit 101 transmits the updated purchase product list to the portable terminal 12.

Determination unit 102 determines whether the registered product included in the purchase product list satisfies the discount condition. The discount condition includes that a set of predetermined products is registered. The list generation unit 101 refers to the discount condition DB 118 and determines, for example, whether there is a set of products satisfying the discount condition in the purchase product list. When there is a set, a discount is applied.

In a case where there is a discount applicable to the registered product, the list generation unit 101 updates the product information in the purchase product list in such a way as to include the discount details.

The discount condition DB 118 stores, for example, discount information in which a discount condition and discount details are associated with each other. The discount condition DB 118 includes at least one discount condition in which purchasing a set of products including three or more predetermined products is requested. The discount condition DB 118 may store discount information with a condition that a set of products including one predetermined product or two predetermined products is purchased as a discount condition. The discount condition indicated by the discount information is represented by, for example, information that can uniquely identify a product that is required to be registered for application of a discount, such as a product ID. The discount details indicate, for example, any of a price, a discount amount, or a discount rate of a product after application of the discount, a price of a set of products, or a discount amount or a discount rate for a set of products.

Among the predetermined products included in the discount condition, a product not included in the purchase product list is also referred to as an unregistered product.

The identification unit 103 identifies a combination of unregistered products including two or more unregistered products that satisfy the discount condition in a case where purchased together with one or more registered products in a set. For example, when the discount condition is to purchase three predetermined products in combination, in a case where one of the predetermined products is registered, the identification unit 103 identifies a combination of the remaining two predetermined products. The product required to satisfy the discount condition is also referred to as a missing product. The identification unit 103 may identify one missing product in a case where the discount condition is satisfied by adding one more product.

The identification unit 103 may identify an unregistered product included in a set each time a product included in the set of products under the discount condition is registered.

The notification unit 104 makes notification to the customer by the notification to the portable terminal 12. In the first example embodiment, the notification unit 104 notifies the portable terminal 12 of the combination of the unregistered products identified by the identification unit 103. For example, when the discount condition is to purchase three predetermined products in combination, in a case where one of the predetermined products is registered, the notification unit 104 notifies the portable terminal 12 of the combination of the remaining two predetermined products. The notification unit 104 may notify the portable terminal 12 of one missing product in a case where the discount condition is satisfied by adding one more product.

In addition to the combination of identified unregistered products and the one missing product identified, the notification unit 104 may make notification of information about a set discount, including a discount condition and details of the discount.

When the registration of the product is completed, the sales management unit 105 generates payment information used for the payment. The payment information includes at least information on the total payment amount for the products registered in the purchase product list. Specifically, the payment information may be the total payment amount itself, or the product information and the quantity necessary for calculating the total payment amount. The payment information may further include a product name of a purchase product, a total quantity of purchase products, information about an applied discount, or information for identifying the payment. The sales management unit 105 may generate a purchase product list in which registration of products is completed as the payment information. The customer ID described above may be used as the information for identifying the payment. For example, the sales management unit 105 updates the sales DB 119 according to the details of the payment.

The storage unit 114 stores, for example, data used for processing of each unit of the POS server 11. Examples of the storage unit include a read only memory (ROM), a random access memory (RAM), a semiconductor memory, a hard disk drive (HDD), and a solid state drive (SSD). The storage unit 114 may be a combination thereof.

The member DB 115 stores member information for each member (customer), for example. The member information is, for example, at least one of a member identifier (ID), a name of the member, a gender of the member, an age or an age group of the member, a member rank, and a contact address of the member. The member ID is, for example, an identifier for uniquely identifying the member. The type of the member ID is not particularly limited. The member ID may be represented by a membership number. The member rank is determined according to, for example, the number of times of use, the frequency of use, the amount of use, and the like of the store. The contact address is a contact address such as an email address, a telephone number, or the like.

The member DB 115 may further store information such as a password, a past purchase history, and a point for each member. The member DB 115 may further store the biometric information for each member. The biometric information is not particularly limited. Examples of the biometric information include face feature amount information, face image data, fingerprint data, iris data, vein data, and the like. Further, the member DB may store the ID of the portable terminal 12 used by the customer. In the case of the portable terminal 12 lent from the store for self-scanning, the ID of the portable terminal 12 is deleted from the member DB after the payment of the purchase product is completed.

The member DB 115 may include settlement information used for electronic settlement. Examples of the electronic settlement include at least one of credit settlement, debit settlement, electronic money settlement, point settlement, and virtual currency settlement. The settlement information is, for example, a credit card number.

The member DB 115 may not include part of the above-described information related to the member. The member DB 115 may include information other than the above-described information about the member.

The product DB 116 stores product information about products handled in a store or an affiliated store including a store. Specifically, the product DB 116 stores product information for each product, for example. The product information stored in the product DB 116 is, for example, information such as a product ID, a product name, a classification of a product, a price of a product, a characteristic of a product, and an inventory status of a product. The product ID is, for example, a code of a product (hereinafter, referred to as a product code). The product code is at least one of a Japanese Article Number (JAN) code, a European Article Number (EAN) code, and a Universal Product Code (UPC). The product ID may be a product name. The classification of the products is not particularly limited. For example, the product may be roughly classified into, for example, a food, a stationery, and the like. The classification of the product may be a classification of confectionery, meat, vegetable, or the like. The price of the product is the unit price of the product before the price reduction is applied. The characteristic of the product is not particularly limited. The characteristic of the product may be a best-before date, a use-by date, a manufacturer name, a vendor name, or the like. The inventory status of the product may be an inventory quantity of the product, an inventory position of the product, or the like.

The product information may include information for identifying the product in addition to the product ID. For example, the product information may include product image data, information about feature amount obtained from the product image data, and the like.

The product DB 116 may not include part of the above-described information about the product. The product DB 116 may include information other than the above-described information about the product.

The purchase product list DB 117 stores, for each customer, the latest purchase product list for which the payment has not been completed. The member ID may be used as a customer ID that uniquely identifies the purchase product list. Alternatively, the purchase product list DB 117 may store the customer ID and the member ID in association with each other. The price of the product is obtained from the product DB 116 based on the product ID of the purchase product list. The purchase product list DB 117 may store the price of the tax-included product calculated based on the price of the tax-excluded product acquired from the product DB 116.

The purchase product list DB 117 may not include part of the above-described information about the purchase product list. The purchase product list DB 117 may include information other than the above-described information about the purchase product list.

The sales DB 119 stores, for example, information about sales of a store for each store. For example, the sales DB 119 may manage information related to each payment for each store. The sales DB 119 stores, for example, a store ID, an ID of the portable terminal 12 that has registered a product, a member ID of a user of the device, a product ID of a purchased product, a purchase quantity, a selling price, and a purchase date and time in association with each other. The store ID is an identifier for uniquely identifying the store.

The sales DB 119 may not include part of the above-described information about sales. The sales DB 119 may include information other than the above-described information about sales.

For example, the sales management unit 105 updates the sales DB 119 according to the details of the payment. For example, the sales DB 119 and the product DB 116 are associated with each other by a product ID. For example, the POS server 11 may update the inventory status of the product DB 116 based on information on the purchase quantity registered in the sales DB 119.

The POS server 11 may not include some of the function units. The POS server 11 may have a function unit not illustrated. The function unit of the POS server 11 illustrated in FIG. 1 may be achieved by a plurality of devices. For example, each function unit may be achieved by two devices including the list generation unit 101 and the sales management unit 105.

For ease of description and understanding, an example in which the POS server 11 includes various DBs will be described, but the present disclosure is not limited thereto. For example, the various DBs may be included in different devices. For example, a server that manages the sales DB 119, a server that manages the member DB 115, and a server that manages the purchase product list DB 117 may be different from each other. In such a case, the server that manages the sales DB 119 and the server that manages the member DB 115 function as database servers. The server that manages the purchase product list DB 117 functions as, for example, an application server. Each server transfers information to be used for the assigned processing via, for example, the communication network 16 or the like.

The portable terminal 12 is a terminal used by a customer. The portable terminal 12 is, for example, a mobile terminal such as a smartphone or a tablet. The type of the portable terminal 12 is not particularly limited. The portable terminal 12 may be owned by a customer or may be lent out at a store. The portable terminal 12 may be attached to a shopping basket or a shopping cart, or may be provided integrally with the shopping basket or the shopping cart. The portable terminal 12 may be movable manually or automatically by including a movable unit and a drive device. The device having the function of the portable terminal 12 includes a mobile terminal, a movable terminal, a moving terminal, and a moving body.

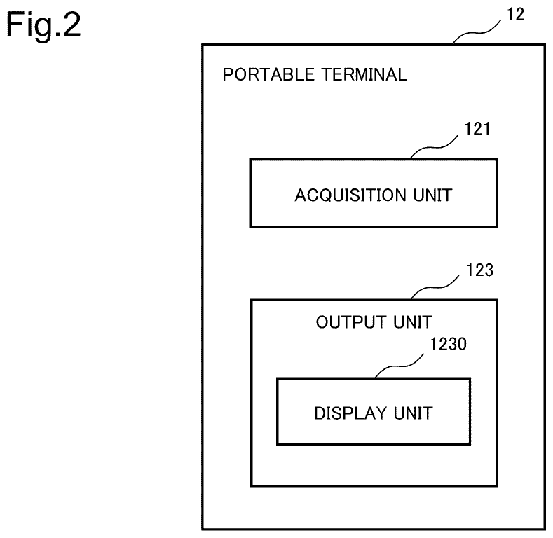

FIG. 2 is a block diagram illustrating a configuration example of the portable terminal 12. The portable terminal 12 includes an acquisition unit 121 and an output unit 123. The output unit 123 includes a display unit 1230. A storage unit (not illustrated) of the portable terminal 12 may store a member ID and an identifier for identifying the portable terminal 12.

The acquisition unit 121 acquires the product ID of the product selected by the customer, transmits an update request including the product ID to the POS server 11, and causes the POS server 11 to register the product as a purchase product. Since the acquisition unit 121 is used to register a product, it may also be referred to as a registration unit. The acquisition unit 121 is an example embodiment of an acquisition means.

The acquisition unit 121 acquires the product ID of the purchase product by reading the product code attached to the product or the like via an imaging device (not illustrated), for example. The imaging device is not particularly limited, but is, for example, a camera included in the portable terminal 12. The product code is the above-described JAN code or the like. The imaging device reads an encoded product code such as a barcode or a two-dimensional code. For example, the acquisition unit 121 may acquire the product ID by identifying the product using the image recognition function from the image of the product captured by the imaging device.

The acquisition unit 121 may acquire the product ID by reading an image of a product or an image of a picture of a product captured in advance via the imaging device. The image may include a product code.

The acquisition unit 121 may acquire the product ID by reading a tag to which a radio frequency identifier (RFID) is attached via a reading device. When RFID is used, the reading device is an RFID reader.

The acquisition unit 121 may acquire the product ID by receiving selection of a product from a result of product search. For example, a product search method is not particularly limited. The product search may be performed by characters. The product search may be performed by the image. For example, the acquisition unit 121 may acquire the product ID by receiving selection of a product to be purchased from the displayed image of the product.

The acquisition unit 121 may acquire the product ID by receiving an input of a number of a JAN code via an input device (not illustrated). Examples of the input device include a touch panel display and a keyboard capable of inputting numbers and characters.

Acquisition unit 121 transmits the acquired product ID to POS server 11. At this time, the acquisition unit 121 also transmits the member ID or the identifier for identifying the portable terminal 12 to the POS server 11. The portable terminal 12 may receive the name and the price of the product related to the transmitted product ID from the POS server 11. At this time, the display unit 1230 displays the name and the price of the product.

The portable terminal 12 receives the purchase product list from the POS server 11.

The display unit 1230 displays the purchase product list received from the POS server 11. The display unit 1230 displays information about the missing product received from the POS server 11.

[Operation]

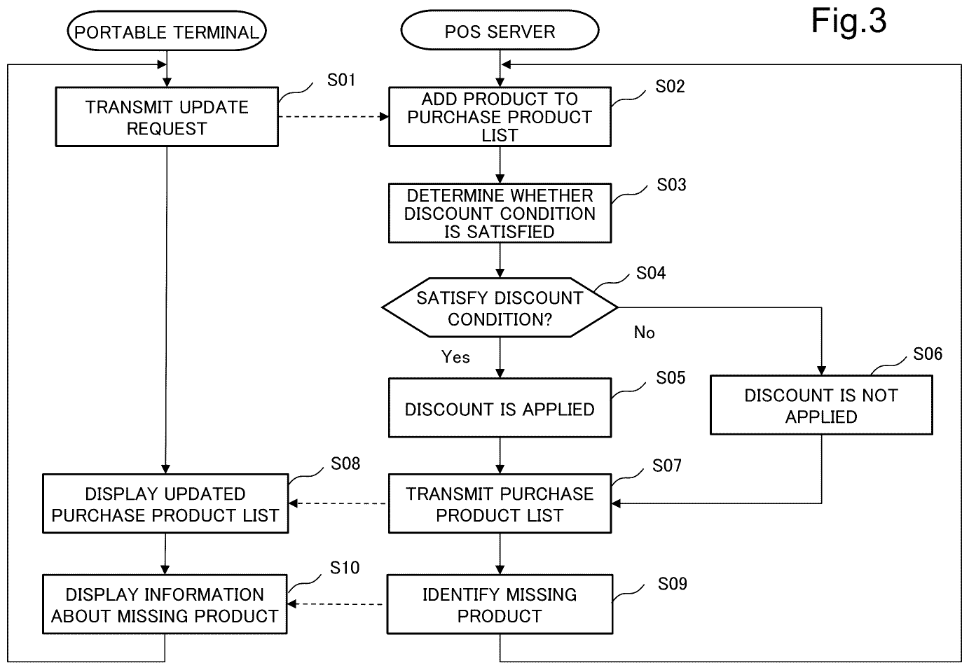

Hereinafter, exemplary operations of the POS server 11 and the portable terminal 12 according to the first example embodiment will be described with reference to the drawings. FIG. 3 is a flowchart illustrating an example of a registration process and a notification process of a missing product.

1. Product Registration

The acquisition unit 121 of the portable terminal 12 acquires the product ID of the purchase product by reading the product code attached to the product or the like, and the portable terminal 12 transmits an update request including the product ID to the POS server 11 (step S01). In addition to the product ID, the update request may include a member ID of the customer, an ID of the portable terminal 12, and the like.

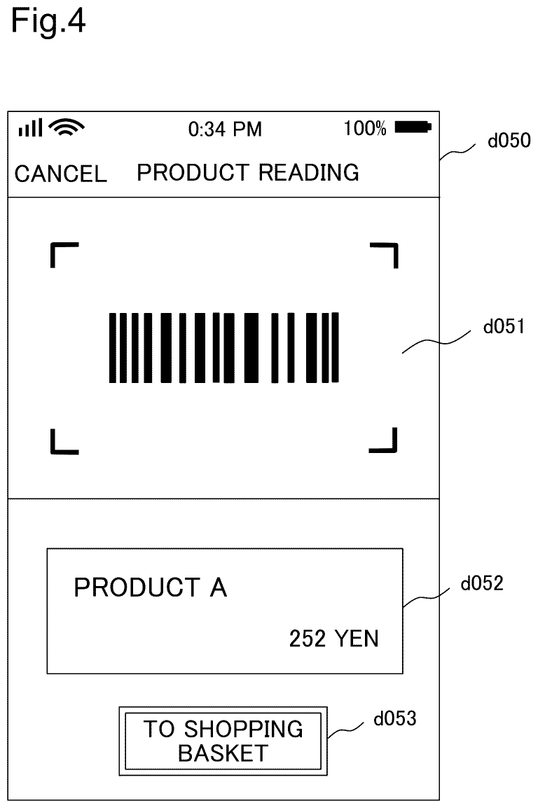

FIG. 4 is a diagram illustrating an example of a product registration screen for reading a product code. The display unit 1230 of the portable terminal 12 displays a screen d050 for reading the product code. For example, the screen d050 includes a reading portion d051, a display field d052 that displays information about a read product, and a button d053 that displays “TO SHOPPING BASKET” for displaying a purchase product list. When the product code of the imaged product is located in the predetermined area of the reading portion d051, the acquisition unit 121 acquires the product ID of the purchase product.

Returning to FIG. 3, the list generation unit 101 of the POS server 11 adds the product included in the update request to the purchase product list of the customer (step S02). The POS server 11 may transmit the product information about the product the product ID of which has been acquired to the portable terminal 12. In this case, the portable terminal 12 displays the received product information. For example, in FIG. 4, in the display field d052, “PRODUCT A” is displayed as the name of the product and 252 yen is displayed as the price of the product of the received product information.

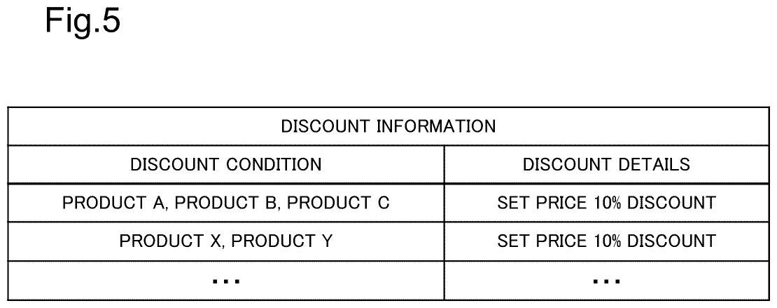

The determination unit 102 refers to the discount information stored in the discount condition DB 118 and determines whether the discount condition is satisfied by the added product (step S03). FIG. 5 is a diagram illustrating an example of discount information stored in the discount condition DB 118. The discount information includes a discount condition and discount details. The first item of the discount information indicates that a discount is applied when the product A, the product B, and the product C are registered as the discount condition. The details of the discount to be applied are a 10% discount on the total amount of the product A, the product B, and the product C.

2. When Discount Condition is Satisfied

When the determination unit 102 determines that the discount condition is satisfied (step S04: Yes), the determination unit 102 transmits the determination result to the list generation unit 101. Based on the determination of the determination unit 102, the list generation unit 101 applies a discount (step S05). That is, in the example of FIG. 5, when the set of the product A, the product B, and the product C has been registered, the determination unit 102 determines that the discount condition is satisfied. The list generation unit 101 includes a 10% discount on the total amount of the products A, B, and C in the purchase product list.

The list generation unit 101 adds the product to transmit the purchase product list to which the discount has been applied to the portable terminal 12 (step S07). The portable terminal 12 displays the updated purchase product list (step S08). For example, in FIG. 4, when the button d053 displaying “TO SHOPPING BASKET” is pressed, the display unit 1230 of the portable terminal 12 displays a purchase product list.

3. When the Discount Condition is not Satisfied

When the determination unit 102 determines that the discount condition is not satisfied (step S04: No), the determination unit 102 also transmits the determination result to the list generation unit 101. In a case where the discount condition is not satisfied, the list generation unit 101 updates the purchase product list by adding the product without applying a discount (step S06) to transmit the updated purchase product list to the portable terminal 12 (step S07). The portable terminal 12 displays the updated purchase product list (step S08).

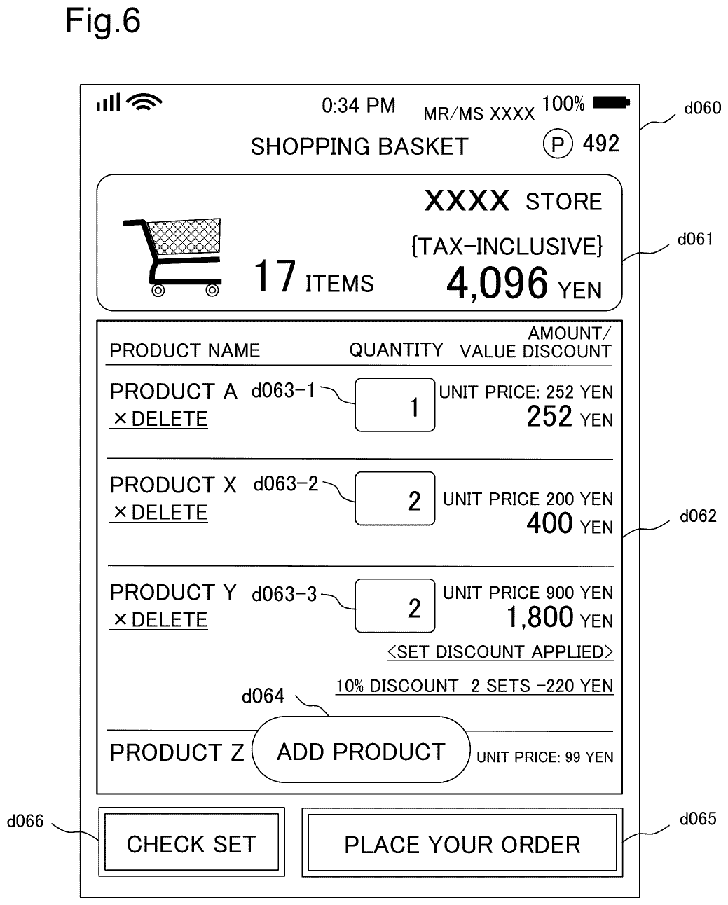

FIG. 6 is a diagram illustrating an example of a screen of a purchase product list displayed on the portable terminal 12. A screen d060 includes, for example, an outline field d061 of the purchase product list, a detail field d062, a product addition button d064, a payment button d065, and a set confirmation button d066. In the outline field d061, for example, information such as the total quantity of products registered in the purchase product list, the amount to be paid, and the store name is displayed. The amount to be paid is, for example, the total amount of the tax-included selling price after the price reduction is applied. In the detail field d062, for example, information such as the name of the product registered in the purchase product list, the purchase quantity, the unit price before discount, the price obtained by multiplying the unit price before discount by the purchase quantity, the discount rate, and the discount amount is displayed for each product. For example, the detail field d062 may have an input field d063 of the purchase quantity for each product. In the detail field d062, for example, the product information may be displayed in descending order of registration. In the detail field d062, for example, a set of products that has already achieved the discount condition may be continuously displayed. Alternatively, for example, even in a case where the achievement of the discount condition has not been performed, a set of products necessary for achieving the condition may be continuously displayed. In the detail field d062, for example, the display order of the product information may be specifiable.

4. Notification of Missing Product

For example, the identification unit 103 identifies a missing product for satisfying the discount condition in the discount condition including the added product (step S09). For example, in the example of FIG. 5, it is assumed that the product B and the product C are not registered when the product A is added. In this case, the identification unit 103 identifies the product B and the product C as the missing products. In a case where the product A has been registered, when the product B has been registered, the identification unit 103 identifies the product C as a missing product. The identification unit 103 may identify the missing product regardless of whether the determination unit 102 determines that there is a set satisfying the discount condition.

The notification unit 104 notifies the identified missing product to the portable terminal 12. In a case where a plurality of missing products is identified for one discount condition, the notification unit 104 makes notification of a combination of the missing products. For example, in the example of FIG. 5, when the product B and the product C are identified, the notification unit 104 makes notification of the combination of the product B and the product C.

The display unit 1230 of the portable terminal 12 displays the information about the missing product based on the notification from the POS server 11 (step S10).

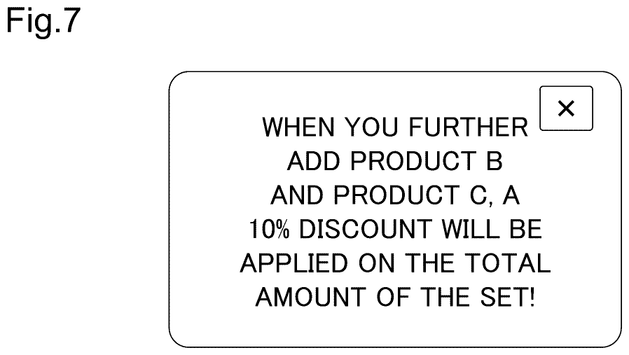

FIG. 7 is a diagram illustrating an example of information about a missing product displayed on the display unit 1230 of the portable terminal 12. The screen of FIG. 7 is popped up in such a way as to be superimposed on the screen d060 of FIG. 6, for example. Alternatively, after the product A is scanned, a pop-up is displayed in such a way as to be superimposed on the screen d050 of FIG. 4. The screen of FIG. 7 displays a combination of products (product B and product C) satisfying the discount condition in a case where they are purchased together with the registered product A in a set. Further, discount details are displayed on the screen of FIG. 7.

The customer who looks at the screen of FIG. 7 may consider adding the product B and the product C. In a case where the pop-up indicating the missing product information is closed, the display unit 1230 may display the pop-up indicating the missing product information again when the set confirmation button d066 is pressed.

5. End of Registration Process

Until the customer finishes product registration, the POS server 11 and the portable terminal 12 repeat the processing of steps S01 to S10. For example, when the product addition button d064 is pressed on the screen of FIG. 6, the portable terminal 12 displays the product registration screen of FIG. 4 and acquires the product identification information. In a case where the payment is made, the portable terminal 12 ends the registration process and advance the process to the payment process. For example, when the payment button d065 is pressed on the screen of FIG. 6, the portable terminal 12 ends the registration of the product.

6. Payment

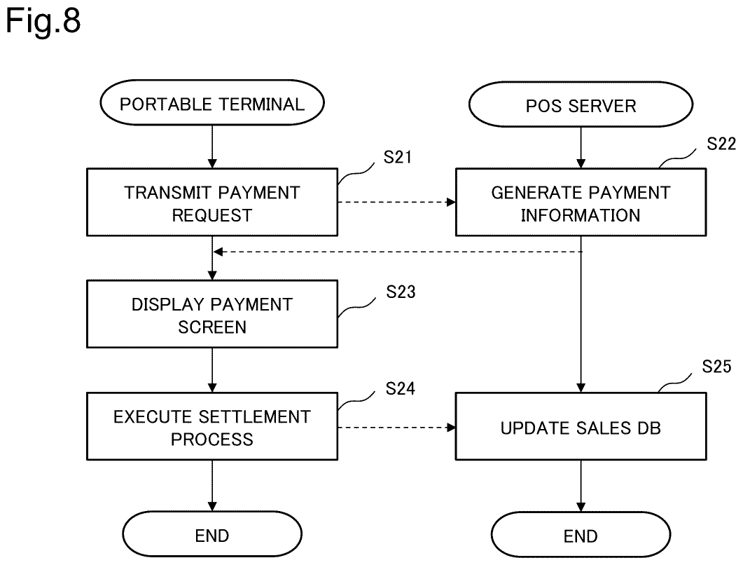

FIG. 8 is a flowchart illustrating an example of a payment process. When the payment process is started, the portable terminal 12 transmits a payment request to the POS server 11 (step S21). The sales management unit 105 of the POS server 11 generates payment information (step S22) to transmit the payment information to the portable terminal 12. The payment information includes, for example, a total payment amount for the purchase product. The portable terminal 12 displays a payment screen (step S23). The payment screen may display settlement information such as the total quantity of the purchase products, the total payment amount for the purchase products, and the last four digits of the credit card number used for electronic settlement. The payment screen may display a settlement process execution button. The portable terminal 12 communicates with a settlement server (not illustrated) using settlement information such as a credit card number stored in the member DB 115, and executes the settlement process (step S24). The portable terminal 12 transmits completion of the settlement process to the POS server 11. When the completion of the settlement process is received, the sales management unit 105 of the POS server 11 updates the sales DB 119. As described above, the POS server 11 and the portable terminal 12 ends the payment process.

In the above operation example, the case of using the settlement information stored in the member DB 115 is described, but the portable terminal 12 may request the customer to input the settlement information each time the payment is performed. In the above operation example, the case where the payment is performed using the portable terminal 12 is described, but the payment may be performed by an any method. For example, the payment may be performed using a payment device (not illustrated) instead of the portable terminal 12.

The description of the operation example according to the first example embodiment ends.

### Effects

According to the first example embodiment, the number of products purchased by the customer can be increased. This is because the identification unit 103 identifies a combination of unregistered products satisfying the discount condition in a case where they are purchased together with a registered product in a set, and the notification unit 104 notifies the portable terminal 12 of the combination of identified unregistered products.

In a case where there is a plurality of unregistered products for one discount condition, the notification unit 104 notifies the customer of the combination of the unregistered products, so that it is possible to indicate to the customer which combination of products is purchased to apply the discount. For example, according to the first example embodiment, in a case where a set includes three or more products, a notification is given for two or more missing products. Therefore, it is possible to propose to the customer that two or more predetermined missing products are added to increase the number of purchase products.

[Modification: Setting of Priority Order]

The priority order may be set to the combination of the missing products notified by the notification unit 104. For example, when the notification unit 104 simultaneously makes notification of the combination of the products B and C and the combination of the products D and E, and the two types of combinations are simultaneously displayed on the portable terminal 12, it may be troublesome for the customer. The notification unit 104 may make notification of the combination of the missing products having the highest priority order. Alternatively, the notification unit 104 may make notification to the portable terminal 12 in such a way as to cause the display unit 1230 of the portable terminal 12 to display a combination of missing products with a higher priority order before or on a combination of missing products with a lower priority order.

Based on the priority order, the identification unit 103 may identify one or more combinations from the combinations of the missing products with high priority order. In this case, the notification unit 104 may make notification of the combination of the missing products identified based on the priority order.

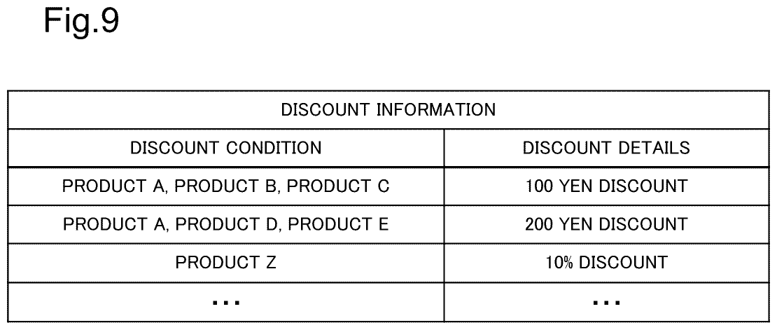

For example, the priority order may be set in descending order of the discount amount indicated by the discount details. FIG. 9 is a diagram illustrating another example of the discount information in the discount condition DB 118. The discount information in FIG. 9 includes two discount conditions in which the product A is included. For example, it is assumed that none of the products B, C, D, and E is registered when the product A is added. In this case, for example, the identification unit 103 first identifies a combination of the products B and C and a combination of the products D and E. Next, the notification unit 104 sets the priority order of the combination of the missing products associated with the discount details having a larger discount amount to be high. For example, the notification unit 104 notifies the portable terminal 12 of the combination of the products D and E having higher priority order and does not make notification of the combination of the products B and C. Alternatively, for example, the notification unit 104 transmits the combination of the products D and E before the combination of the products B and C.

The priority order may be set in ascending order of the number of missing products. For example, the notification unit 104 may make notification of a combination of two missing products with priority over a combination of three missing products.

The priority order may be set based on the purchase history of the customer. For example, the notification unit 104 may set the priority order of a combination including a product purchased in the past as a missing product to be high. Alternatively, the priority order may be set based on a browsing history of an e-commerce site, a browsing history of a social network service, or event schedule information of a customer stored in the member DB 115. For example, a probability that a customer purchases a product browsed on an e-commerce site or a product recommended by a social network service is high. The event schedule information is information about an event in which a customer is scheduled to participate. For example, in a case where the customer registers the schedule of camping, the probability that the customer purchases camping equipment is high. As described above, the priority order can be appropriately set in such a way that the probability that the customer purchases the missing product increases.

[Modification: Case where Plurality of Sets Competes]

For example, it is assumed that the customer registers the products A, B, C, D, and E when the discount information of FIG. 9 is stored. At this time, which set discount of the set of the products A, B, and C and the set of the products A, D, and E is applied is a problem. In a case where the registered product is included in a plurality of discount conditions, the determination unit 102 determines which set discount is applied by determining which discount condition is satisfied.

For example, the determination unit 102 determines that the discount condition in which the set of products is registered earlier is satisfied based on the order in which the products are registered. Alternatively, the determination unit 102 may determine that the discount condition with a high discount amount is satisfied based on the discount details.

The determination unit 102 may determine that the discount condition of the set discount selected by the customer is satisfied. In this case, the display unit 1230 of the portable terminal 12 displays a screen on which the set discount to be applied can be selected.

In the above example, the determination unit 102 may determine that both the set discount of the products A, B, and C and the set discount of the products A, D, and E are applied.

[Modification: Determination of Applied Set Discount]

In one shopping, a plurality of types of set discounts may be applicable to a plurality of sets. Alternatively, one set discount may be set to be applicable in one shopping. In this case, as in a case where a plurality of sets conflict with each other, the determination unit 102 determines a set discount to be applied.

[Modification: Various Types of Set Discount]

In the description of the above operation example, the case where the details of the applied discount are a 10% discount on the total amount of the prices of the product A, the product B, and the product C is described. However, the details of the discount are not limited thereto. The discount may be a discount for each product included in the discount condition. For example, the price of each of the product A, the product B, and the product C may be reduced by a predetermined amount.

The discount may be a discount on at least one of the products included in the discount condition. For example, in a case where the discount condition includes the products A, B, and C, the discount may be a discount for each of the product B and the product C without a discount for the product A.

The discount may be to sell products included in the discount condition at a set price. For example, in the discount, a set of the products A, B, and C may be sold at 500 yen when the total price of the products A, B, and C is 600 yen.

Alternatively, in a case where the discount condition is satisfied, each of all the products in the purchase product list may be discounted. A discount may be performed on the total amount of all the products in the purchase product list.

[Modification: User Interface]

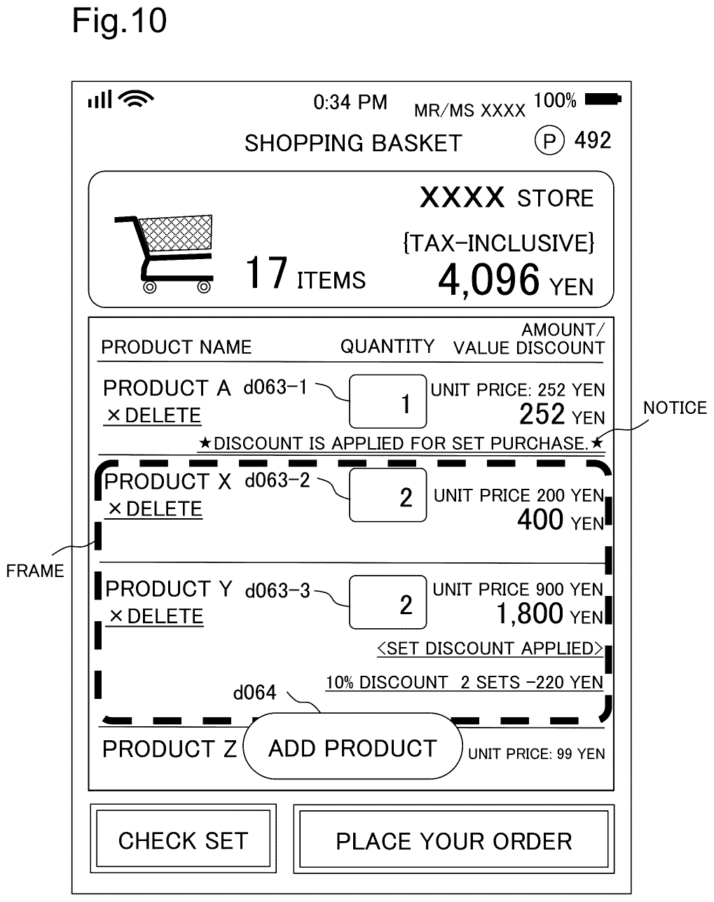

When all the products included in the discount condition are registered, the display unit 1230 may display the products included in the set for easy understanding. FIG. 10 is a diagram illustrating another example of the screen of the purchase product list displayed on the portable terminal 12. As illustrated in FIG. 10, the products constituting the set may be surrounded by a frame. Alternatively, the products constituting the set may be displayed in the same color. Even in a case where none of the products included in the discount condition are registered, the combination of the products included in the discount condition may be displayed in such a way as to be recognized in the purchase product list.

The display unit 1230 may display that there is an unregistered product satisfying the discount condition when it is purchased together with the registered product in a set. For example, in FIG. 10, a notice is displayed as the information about the product A. When the notice is pushed by the customer, information about the missing product may be displayed. The display unit 1230 may display, for example, a screen as illustrated in FIG. 7. A similar notice may be displayed in the display field d052 of FIG. 4.

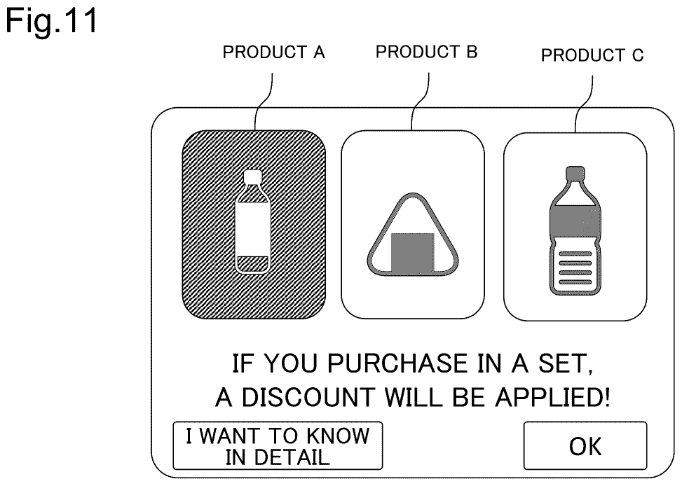

When the notification unit 104 makes notification of the combination of the missing products, the notification unit 104 may make notification of the registered products necessary for achieving the discount condition together with the combination of the missing products. That is, the notification unit 104 may make notification of all the products constituting the set of products necessary for achieving the discount condition. At this time, the display unit 1230 of the portable terminal 12 displays the registered product and the missing product in such a way that the registered product and the missing product can be distinguished. FIG. 11 is a diagram illustrating another example of the missing product information displayed on the portable terminal 12. The image of FIG. 11 may be displayed on the product registration screen or the purchase product list screen, as in the image of FIG. 7.

FIG. 11 illustrates that product A has been registered, and products B and C need to be registered to achieve the discount condition. The registered product is grayed out, for example. As illustrated in FIG. 11, the missing product may be represented by an image. When the missing product is displayed, another information related to the product such as the price of the missing product may be displayed.

### Second Example Embodiment

Next, an information processing system 10 according to the second example embodiment will be described with reference to the drawings. In the second example embodiment, a basic configuration of the contents described in the first example embodiment will be described.

[Configuration]

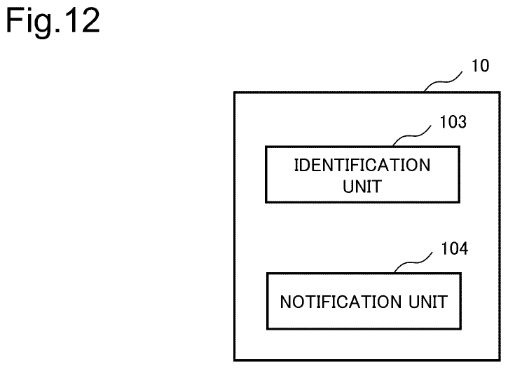

FIG. 12 is a diagram illustrating a configuration of an information processing system 10 according to the second example embodiment. The information processing system 10 includes the identification unit 103 and the notification unit 104.

The information processing system 10 is connected to a server having the functions of the list generation unit 101, the determination unit 102, the sales management unit 105, and the storage unit 114 according to the first example embodiment via a network. Further, the information processing system 10 communicates with a portable terminal operated by a customer through a network. The information processing system 10 may include some or all of the functions related to the POS server 11 of the first example embodiment. The portable terminal may have the functions of the list generation unit 101 and the determination unit 102 instead of the POS server.

When the discount condition is satisfied in a case where two or more unregistered products and one or more registered products registered using the portable terminal by the operation by the customer are purchased in a set, the identification unit 103 identifies a combination of unregistered products including the two or more unregistered products.

The notification unit 104 notifies the portable terminal of the combination of identified unregistered products.

[Operation]

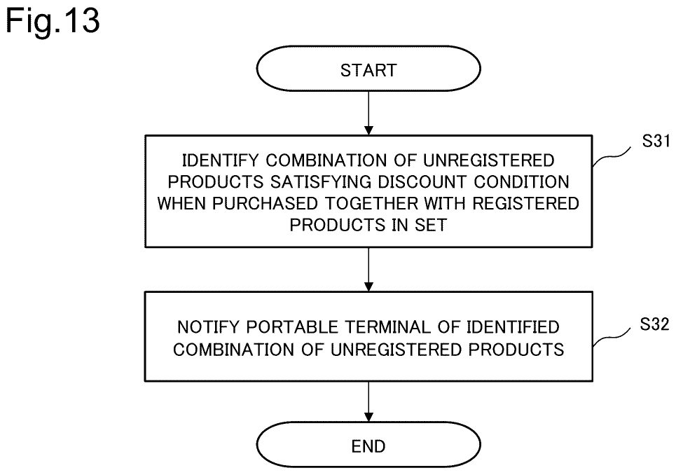

FIG. 13 is a flowchart illustrating an operation example of the information processing system 10 according to the second example embodiment. First, a product to be purchased by a customer is registered using a portable terminal by an operation by the customer. The identification unit 103 identifies a combination of unregistered products that satisfies the discount condition when they are purchased together with the registered products in a set (step S31). The notification unit 104 notifies the portable terminal operated by the customer of the combination of identified unregistered products (step S32).

### Effects

According to the second example embodiment, the number of products purchased by the customer can be increased. This is because the identification unit 103 identifies a combination of unregistered products including two or more unregistered products when the discount condition is satisfied in a case where the two or more unregistered products and the one or more registered products registered using the portable terminal by the operation by the customer are purchased in a set. This is also because the notification unit 104 notifies the portable terminal operated by the customer of the combination of identified unregistered products.

(Hardware Configuration)

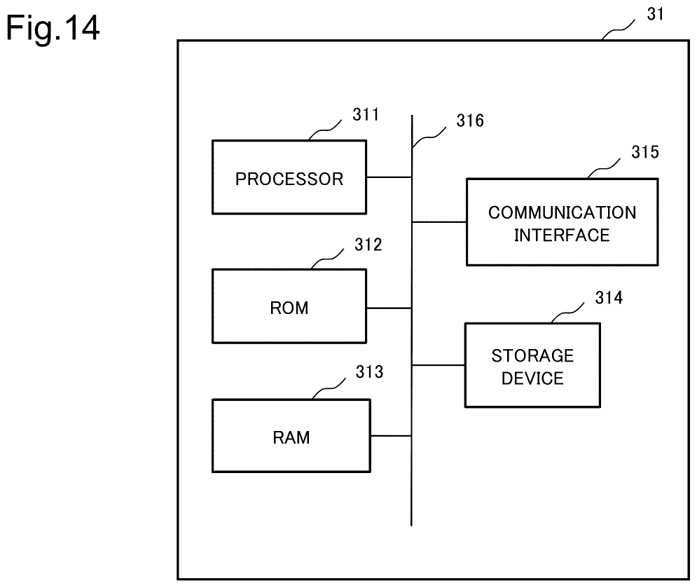

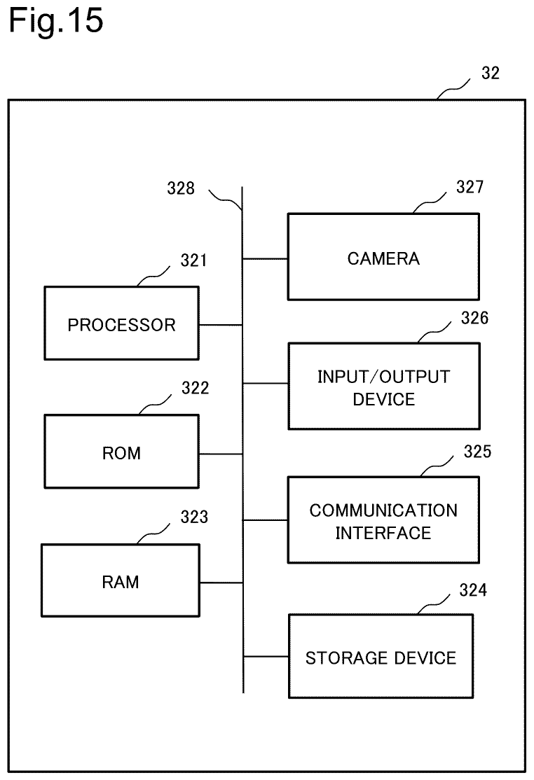

The description of each example embodiment ends. Next, hardware configurations of the information processing system 10, the POS server 11, and the portable terminal 12 will be described. FIGS. 14 and 15 are explanatory diagrams illustrating a hardware configuration example of the system.

In each of the above-described example embodiments, each component of the information processing system 10 and the POS server 11 represents a functional unit block. Part or all of each component may be achieved by an any combination of the computer 31 and the program. There are various modifications of the method for implementing the information processing system 10 and the POS server 11. For example, the information processing system 10 and the POS server 11 may be achieved by a single computer 31. The plurality of components included in each device may be achieved by respective computers 31.

A hardware configuration example of the computer 31 illustrated in FIG. 14 will be described. The computer 31 includes, for example, a processor 311, a ROM 312, a RAM 313, a storage device 314, and a communication interface 315. Each components of the computer 31 is connected via a bus 316.

Next, a hardware configuration example of a portable terminal 32 illustrated in FIG. 15 will be described. The portable terminal 32 is an example in which the portable terminal 12 described in the first example embodiment is achieved by a computer. The portable terminal 32 includes a processor 321, a ROM 322, a RAM 323, a storage device 324, a communication interface 325, an input/output device 326, and a camera 327. Each component of the portable terminal 32 is connected via a bus 328.

The processors 311 and 321 control the computer 31 or the portable terminal 32, entirely. Examples of the processors 311 and 321 include a central processing unit (CPU), a digital signal processor (DSP), and the like. The computer 31 and the portable terminal 32 include, as storage units, the ROMs 312 and 322, RAMs 313 and 323, the storage devices 314 and 324, and the like. Examples of the storage devices 314 and 324 include a semiconductor memory such as a flash memory, an HDD, and an SSD. For example, the storage devices 314 and 324 store an operating system (OS) program, an application program, and the like. Alternatively, the ROMs 312 and 322 store an application program. Then, the RAMs 313 and 323 are used as work areas of the processors 311 and 321.

The processors 311 and 321 load programs stored in the storage devices 314 and 324, the ROMs 312 and 322, and the like. Then, the processors 311 and 321 execute respective processes coded in the program. The processors 311 and 321 may download various programs via a communication network. The processors 311 and 321 function as part or all of the computer 31 or the portable terminal 32. Then, the processors 311 and 321 may execute processing or instructions in the illustrated flowchart based on a program.

The communication interfaces 315 and 325 are connected to a communication network such as a local area network (LAN) or a wide area network (WAN) through a wireless or wired communication line. As a result, the computer 31 and the portable terminal 32 are connected to an external device or an external computer via the communication network. The communication interfaces 315 and 325 control interfaces between the communication network and the inside of the computer 31 and the portable terminal 32. Then, the communication interfaces 315 and 325 control input/output of data from an external device or an external computer.

The hardware configuration illustrated in FIGS. 14 and 15 is an example. Components other than the components illustrated in the drawings may be added, or some components may not be included. For example, the computer 31 may have an input device such as a keyboard, a mouse, and a physical button.

The description of the hardware configuration of each device ends. There are various modifications in a method of achieving each device. For example, the system may be achieved by any combination of computers and programs different for respective components. A plurality of components included in each device may be achieved by any combination of one computer and a program.

Part or all of each component of the system may be achieved by an application specific circuit. Part or all of the system may be achieved by a general-purpose circuit including a processor such as a field programmable gate array (FPGA). Part or all of the system may be achieved by a combination of an application specific circuit, a general-purpose circuit, and the like. The circuit may be a single integrated circuit. Alternatively, the circuit may be divided into a plurality of integrated circuits. The plurality of integrated circuits may be configured by being connected via a bus or the like.

When part or all of each component of each device is achieved by a plurality of computers, circuits, and the like, the plurality of computers, circuits, and the like may be disposed in a centralized manner or in a distributed manner.

The methods described in the embodiments can be implemented by the information processing system, the POS server, or the portable terminal. The method is implemented by a computer such as an information processing system, a POS server, or a portable terminal executing a program prepared in advance. The program is recorded in a computer-readable recording medium such as an HDD, an SSD, a flexible disk, an optical disk, a flexible disk, a magnetic optical disk, or a USB memory. Then, the program is executed by being read from the recording medium by the computer. The program may be distributed via the communication network.

The functions of the components of the system according to each example embodiment described above may be implemented by hardware like the computer system illustrated in FIGS. 14 and 15. Alternatively, each component may be achieved by a computer device or firmware based on program control.

While the present disclosure is described with reference to example embodiments thereof, the present disclosure is not limited to these example embodiments. The configurations and details of the present disclosure may include example embodiments to which various changes that can be grasped by those of ordinary skill within the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

Some or all of the above example embodiments may be described as the following Supplementary Notes, but are not limited to the following.

### [Supplementary Note 1]

An information processing system including an identification means configured to identify, when a discount condition is satisfied in a case where two or more unregistered products and one or more registered products that were registered by an operation by a customer using a portable terminal are purchased in a set, a combination of the unregistered products including the two or more unregistered products, and
a notification means configured to notify the portable terminal of the identified combination of the unregistered products.

### [Supplementary Note 2]

The information processing system according to Supplementary Note 1, wherein the discount condition is satisfied by purchasing a set of products including three or more predetermined products.

### [Supplementary Note 3]

The information processing system according to Supplementary Note 2, wherein
the identification means identifies a combination of the unregistered products each time a product included in the set of products is registered.

### [Supplementary Note 4]

The information processing system according to any one of Supplementary Notes 1 to 3, wherein
a discount applied when the discount condition is satisfied is at least any of
a discount on at least one of products included in the discount condition,
a discount on each of products included in the discount condition,
a discount on a total amount of products included in the discount condition,
a sale of products included in the discount condition at a set price,
a discount on a total amount of all registered products, and
a discount on each of all registered products.

### [Supplementary Note 5]

The information processing system according to any one of Supplementary Notes 1 to 4, wherein
when there is a plurality of combinations of the unregistered products that satisfies the discount condition in a case where the unregistered products are purchased in combination with the registered products,
the notification means makes notification of a combination of the unregistered products using a priority order set based on at least any of a purchase history, a browsing history of an e-commerce site, a browsing history of a social network service, or event schedule information of the customer.

### [Supplementary Note 6]

The information processing system according to any one of Supplementary Notes 1 to 5, wherein
the identification means further identifies, when the discount condition is satisfied in a case where one of the unregistered products and two or more of the registered products are purchased in a set, the one unregistered product, and wherein
the notification means notifies the portable terminal of the identified one unregistered product.

### [Supplementary Note 7]

The information processing system according to any one of Supplementary Notes 1 to 6, wherein
the notification means further notifies the portable terminal of details of a discount applied when the discount condition is satisfied.

### [Supplementary Note 8]

The information processing system according to any one of Supplementary Notes 1 to 7, further including
a determination means configured to
determine that either the discount condition selected by the customer or the discount condition with a highest discount amount is satisfied, or
determine that any of the plurality of discount conditions is satisfied
when all products included in each of the plurality of discount conditions are registered, and one of the registered products is included in any of the plurality of discount conditions.

### [Supplementary Note 9]

A notification providing method including
identifying, when a discount condition is satisfied in a case where two or more unregistered products and one or more registered products that were registered by an operation by a customer using a portable terminal are purchased in a set, a combination of the unregistered
products including the two or more unregistered products, and notifying the portable terminal of the identified combination of the unregistered products.

### [Supplementary Note 10]

A recording medium non-transitorily recording a program for causing a computer to function as
an identification means configured to identify, when a discount condition is satisfied in a case where two or more unregistered products and one or more registered products that were registered by an operation by a customer using a portable terminal are purchased in a set, a combination of the unregistered products including the two or more unregistered products, and
a notification means configured to notify the portable terminal of the identified combination of the unregistered products.

### [Supplementary Note 11]

A portable terminal including
an acquisition means configured to acquire identification information about a product by an operation by a customer, and
a display means configured to display, when a discount condition is satisfied in a case where a registered product the identification information of which is acquired and that is registered and two or more unregistered products are purchased in a set, a combination of unregistered products including the two or more unregistered products.

### [Supplementary Note 12]

The portable terminal according to Supplementary Note 11, wherein
the display means displays a combination of the unregistered products on an acquisition screen of the identification information or a list screen of registered products.

### [Supplementary Note 13]

The portable terminal according to Supplementary Note 11 or 12, wherein
the display means displays a set of products under the discount condition in such a way that the registered products and a combination of the two or more unregistered products are identifiable.

### [Supplementary Note 14]

A recording medium non-transitorily recording a program for causing a computer to function as
an acquisition means configured to acquire identification information about a product by an operation by a customer, and
a display means configured to display, when a discount condition is satisfied in a case where a registered product the identification information of which is acquired and that is registered and two or more unregistered products are purchased in a set, a combination of unregistered products including the two or more unregistered products.

### [Supplementary Note 15]

An information processing system including
an identification means configured to identify, when a discount condition is purchasing a set of three predetermined products, an unregistered product among the three predetermined products, and
a notification means configured to
notify the portable terminal that a purchase amount is discounted by purchasing remaining two of the predetermined products when one of the predetermined products is registered using a portable terminal by an operation by a customer, and
further notify, when one predetermined product of the remaining two predetermined products is registered, the portable terminal that a discount is given by purchasing the other predetermined product.

### REFERENCE SIGNS LIST

1, 10 information processing system
11 POS server
12 portable terminal
101 list generation unit
102 determination unit
103 identification unit
104 notification unit
105 sales management unit
114 storage unit
115 member DB
116 product DB
117 purchase product list DB
118 discount condition DB
119 sales DB

What is claimed is:

1. An information processing system comprising:
at least one memory configured to store instructions; and
at least one processor configured to execute the instructions to:
identify, when a discount condition is satisfied in a case where two or more unregistered products and one or more registered products that were registered by an operation by a customer using a portable terminal are purchased in a set, a combination of the unregistered products including the two or more unregistered products; and
notify the portable terminal of the identified combination of the unregistered products.

2. The information processing system according to claim 1, wherein
the discount condition is satisfied by purchasing a set of products including three or more predetermined products.

3. The information processing system according to claim 2, wherein the at least one processor is further configured to execute the instructions to:
identify a combination of the unregistered products each time a product included in the set of products is registered.

4. The information processing system according to claim 1, wherein
a discount applied when the discount condition is satisfied is at least any of
a discount on at least one of products included in the discount condition,
a discount on each of products included in the discount condition,
a discount on a total amount of products included in the discount condition,
a sale of products included in the discount condition at a set price,
a discount on a total amount of all registered products, and
a discount on each of all registered products.

5. The information processing system according to claim 1, wherein the at least one processor is further configured to execute the instructions to:
identify a plurality of combinations of the unregistered products that satisfies the discount condition in a case where the unregistered products are purchased in combination with the registered products; and
notify a combination of the unregistered products using a priority order set based on at least any of a purchase history, a browsing history of an e-commerce site, a browsing history of a social network service, or event schedule information of the customer.

6. The information processing system according to claim 1, wherein the at least one processor is further configured to execute the instructions to:
identify, when the discount condition is satisfied in a case where one of the unregistered products and two or more of the registered products are purchased in a set, the one unregistered product; and
notify the portable terminal of the identified one unregistered product.

7. The information processing system according to claim 1, wherein the at least one processor is further configured to execute the instructions to:
notify the portable terminal of details of a discount applied when the discount condition is satisfied.

8. The information processing system according to claim 1, wherein the at least one processor is further configured to execute the instructions to:
when all products included in each of the plurality of discount conditions are registered, and one of the registered products is included in any of the plurality of discount conditions, determine that the discount condition satisfied is any of
the discount condition selected by the customer,
the discount condition with a highest discount amount, and
all of the plurality of discount conditions.

9. A notification providing method comprising:
identifying, when a discount condition is satisfied in a case where two or more unregistered products and one or more registered products that were registered by an operation by a customer using a portable terminal are purchased in a set, a combination of the unregistered products including the two or more unregistered products; and
notifying the portable terminal of the identified combination of the unregistered products.

10. (canceled)

11. A portable terminal comprising:
at least one memory configured to store instructions; and
at least one processor configured to execute the instructions to:
acquire identification information about a product by an operation by a customer; and
display, when a discount condition is satisfied in a case where a registered product the identification information of which is acquired and that is registered and two or more unregistered products are purchased in a set, a combination of unregistered products including the two or more unregistered products.

12. The portable terminal according to claim 11, wherein the at least one processor is further configured to execute the instructions to:
display a combination of the unregistered products on an acquisition screen of the identification information or a list screen of a registered product.

13. The portable terminal according to claim 11, wherein the at least one processor is further configured to execute the instructions to:
display a set of products under the discount condition in such a way that the registered product and a combination of the two or more unregistered products are identifiable.

14. (canceled)
